(19) United States
(12) Patent Application Publication
(10) Pub. No.: US 2009/0148747 A1
(43) Pub. Date: Jun. 11, 2009

(54) Water flow system for a fuel cell

(75) Inventors: Jin-Shu Huang, Hsinchu (TW); Nien-Hui Hsu, Hsinchu (TW); Cheng Wang, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsinchu (TW)

(21) Appl. No.: 12/230,145

(22) Filed: Aug. 25, 2008

(30) Foreign Application Priority Data
Dec. 7, 2007 (TW) 096146662

(51) Int. Cl. H01M 8/04

(52) U.S. Cl. 429/34

(57) ABSTRACT

Provided is a water flow system for a fuel cell. The fuel cell includes a battery module. The battery module has a cathode end and an anode end. The water flow system includes a water absorbing material and a pump. The water absorbing material has a first capillary structure and a second capillary structure. One end of the second capillary structure is connected to the first capillary structure. The first capillary structure contacts the cathode end of the battery module. The second capillary structure is disposed outside the battery module and is separated from the cathode end. One end of the pump is connected to the other end of the second capillary structure of the water absorbing material to pump the water in the second capillary structure.

### BACKGROUND OF THE INVENTION

(1) Field of the Invention

The present invention relates to a water flow system, and more particularly relates to the water flow system used for recycling the cathode water of a fuel cell.

(2) Description of the Prior Art

The exploitation and application of energy destroy the environment day by day. Due to the advantages of high efficiency, low noise and no pollution, the fuel cell accords with the environmental protection trend. There are many types of fuel cells, in which proton exchange membrane fuel cell (PEMFC) and direct methanol fuel cell (DMFC) are most popular. The fuel for PEMFC is hydrogen, while the fuel for DMFC is methanol, but the two types have a similar structure.

Refer to FIG. 1 for a basic structure of a conventional fuel cell in the example of DMFC. A fuel cell 100 usually includes a battery module 120, a fuel supply system 140 and a water flow system 160. The battery module 120 has a cathode end 122, an anode end 124 and a proton exchange membrane 126 as FIG. 2 shows. The fuel supply system 140 provides fuel for the anode end 124 of the battery module 120. The water flow system 160 collects the condensing water on a surface of the cathode end 122, called cathode water. The detailed description of the battery module 120 and the water flow system 160 is as below.

Referring to FIG. 2, the fuel (methanol) in the anode end 124 reacts with a catalyzer 128 to generate hydrogen ions and electrons. The anode half reaction is CH₃OH+H₂O→CO₂+6H⁺+6e⁻. The electrons in the anode end 124 get to the cathode end 122 through an external circuit 200. The hydrogen ions get to the cathode end 122 by penetrating the proton exchange membrane 126 and then react with electrons and oxygen to generate water. The cathode half reaction is 6H⁺+6e⁻+3/2O₂→3H₂O.

In FIG. 2, the cathode end 122 of the battery module 120 is disposed by one side of the proton exchange membrane 126. The cathode end 122 includes an catalyzer layer 121, a gas diffusion layer 123, an current collector 125 and a flow-field plate 127. The cathode half reaction usually happens at the catalyzer layer 121. As above-mentioned, the hydrogen ions generated by the anode half reaction penetrate the proton exchange membrane 126, and the electrons generated by the anode half reaction go along the external circuit 200 and arrive the catalyzer layer 121 by the current collector 125. The air (oxygen) gets into the battery module 120 along the flow-field plate 127, then goes through the through holes 129 of the current collector 125, and finally diffuses onto the surface of the catalyzer layer 121 through the gas diffusion layer 123. The cathode half reaction of the DMFC generates the cathode water, while the anode half reaction needs water besides methanol. Thus the cathode water may be recycled to the anode end 124.

Referring to FIG. 1, for the fuel control and water recovery, the process of the water flow system 160 is as follows: a blower 162 blows oxygen to the cathode end 122 of the battery module 120, then evaporates the cathode water and brings it to a water tank 164 for condensation. The process of the fuel supply system 140 is as follows: a circulation pump 142 pumps the fuel from the mixing tank 144, and sends it to the anode end 124 of the battery module 120. The fuel after reaction reflows to the mixing tank 144 to complete the circulation.

During the running of the fuel cell 100, the anode end 124 of the battery module 120 consumes methanol continuously, so the concentration of the methanol solution in the mixing tank 144 will decrease gradually with time. A water pump 146 and a fuel pump 148 are needed to supply water and high concentration methanol to keep the fuel in a predetermined concentration range. When the fuel concentration in the mixing tank 144 is lower than the minimum of the predetermined concentration range, the fuel lo pump 148 is used to supply methanol. When the fuel concentration in the mixing tank 144 is higher than the maximum of the predetermined concentration range, the water pump 146 is turned on to supply water and the fuel pump 148 is turned off to stop the supplement of methanol. In this way, the fuel concentration in the mixing tank 144 is controlled in the predetermined concentration range.

Refer to FIG. 3 for another conventional fuel cell 100a. In the water flow system 160a of the fuel cell 100a, the cathode water directly drops into the mixing tank 144 by gravity. The concentration of the methanol solution is controlled by reading out the concentration value of the mixing tank 144 directly. If the concentration value is lower than a preset concentration, the fuel pump 148 is turned on to pump the high concentration methanol into the mixing tank 144 to control the concentration.

There are disadvantages both in the fuel cell 100 and 100a as shown in FIG. 1 and FIG. 3. In FIG. 1, the two pumps 146 and 148 are used to supply water and high concentration methanol, which makes the system expensive. In addition, the water tank is designed large, which increases the volume of the fuel cell 100, and makes miniaturization hard. In FIG. 3, though there is no water pump 146, and the water drops by its gravity for supplement, it limits the height of the water flow system 160a, and also makes it hard to miniaturize the fuel cell 100a. Furthermore, because the mixing tank 144 is connected with the water tank 164, some fuel may flow to the water tank 164 through the mixing tank 144 during the running of the circulation pump 142, which causes the leakage of a fuel supply system 140a.

It is noticeable that no matter what process of the water recovery is, the water tank 164 have an opening (not shown) connected to the outside for the air flow to pass and water to coagulate. If the fuel cell 100 and 100a are portable, when they are turned off and carried by, the water may leak out through the opening (not shown) of the water tank 164, which makes it inconvenient to take.

Moreover, during the cathode water recovery, the cathode water gets into the gas diffusion layer 123 from the surface of the catalyzer layer 121, then goes through the through holes 129 of the current collector 125, and flows out of the battery module 120 along the flow-field plate 127, finally enters the water flow system 160 or 160a. However, if the water does not flow away smoothly when diffusing, it may be blocked by the outer side of the catalyzer layer 121. Now there are two ways for the problem, the first is to pump the water from the flow-field plate by an air pump, which is suitable for the flow-field plate 127A in FIG. 4A, but the air pump has a strong push power, large noise and high power consumption, and the air pump is also too large for the small fuel cell product, besides that, its life is short and commercialization is low; the second is to blow the water by the fan, which is suitable for the flow-field plate 127B in FIG. 4B. No matter what kind of the flow-field plate 127A or 127B, if there is water blocked in the flow-field plate 127A or 127B or the corner of the flow-field plate 127A, it is hard to bring the water out by the air pump or fan.

In conclusion, the water recovery technology uses air flow to help the cathode water transform into gaseous water and brings the gaseous water away from the surface of the cathode end, and coagulates the gaseous water into liquid water at the downstream and then pumps the liquid water to the anode end. There are following problems to be solved:

1. Low water recovery rate: the water recovery technology uses air flow to help the cathode water transform into gaseous water and bring the gaseous water away from the surface of the cathode, and coagulate the gaseous water into liquid water. After the liquid water is vaporized into high temperature gaseous water, it may not be coagulated on the condenser completely, most of the gaseous water dispersing with the air flow out of the fuel cell.

2. Water leakage: when the fuel cell is inclined, the liquid water around the condenser will flow out of the exhaust gas hole.

3. Energy consumption: a fan is needed to bring environmental air to cool the condenser to keep its low temperature.

4. Not easy to keep the temperature of the fuel cell at a high level: a lot of air flows the surface of the cathode end to ensure the evaporation of the cathode water, which decreases the temperature of the battery module.

### SUMMARY OF THE INVENTION

The present invention is to provide a water flow system for a fuel cell, in order to increase water recovery rate, to save the energy consumed in water recycling, to avoid water leakage and to avoid decreasing the temperature of the battery module in the fuel cell.

An embodiment of the present invention provides a water flow system for a fuel cell. The fuel cell includes a battery module which has a cathode end and an anode end. The water flow system includes a water absorbing material and a pump. The absorbing material has a first capillary structure and a second capillary structure. One end of the second capillary structure is connected to the first capillary structure. The first capillary structure contacts the cathode end of the battery module and the second capillary structure is disposed outside the battery module and is separated from the cathode end. One end of the pump is connected to the other end of the second capillary structure of the water absorbing material to pump the water in the second capillary structure.

According to the embodiment, the present invention provides a fuel cell including a battery module, a water absorbing material, a three-way valve, a mixing tank, a fuel tank and a pump. The battery module having a cathode end and an anode end. The water absorbing material has a first capillary structure and a second capillary structure. One end of the second capillary structure is connected to the first capillary structure. The first capillary structure contacts the cathode end of the battery module. The second capillary structure is disposed outside the battery module and is separated from the cathode end. The three-way valve has a first connection, a second connection and a third connection. The first connection is connected to the second capillary structure of the water absorbing material. The mixing tank is connected with the second connection of the three-way valve. The fuel tank is connected with the mixing tank. The pump is connected with the third connection of the three-way valve to pump the water from the second capillary structure and the pump is also connected with the anode end of the battery module.

In an embodiment of the present invention, a fuel cell includes a battery module, a water absorbing material and a pump. The battery module has a cathode end and an anode end. The water absorbing material has a first capillary structure and a second capillary structure. One end of the second capillary structure is connected to the first capillary structure. The first capillary structure contacts the cathode end of the battery module. The second capillary structure is disposed outside the battery module and separated from the cathode end. The pump is connected with the other end of the second capillary structure of the water absorbing material to pump the water from the second capillary structure.

In an embodiment of the present invention, the fuel cell further includes a fuel tank and a mixing tank. The fuel tank supplies fuel. The mixing tank accepts the water from the pump and the fuel from the fuel tank and mixes the water with the fuel, as well as sends the mixture of the water and the fuel to the anode end of the battery module.

In an embodiment of the present invention, the fuel cell further includes a three-way valve, which has a first connection, a second connection and a third connection. The first connection is connected to the other end of the second capillary structure. The second connection is connected to the fuel tank. The third connection is connected to the pump so as to make the pump connected to the other end of the second capillary structure of the water absorbing material through the first connection and the third connection. The pump selectively pumps the water from the second capillary structure or the fuel from the fuel tank to the mixing tank.

In an embodiment of the present invention, the battery module includes a plurality of membrane electrode assemblies, and each of the membrane electrode assembly includes two anode structures and two cathode structures. The two cathode structures are respectively disposed at two outside surfaces of the membrane electrode assembly, and the two anode structures are disposed between inside surfaces of the two cathode structures.

In an embodiment of the present invention, the water absorbing material is a cotton thread or a man-made fiber. The first capillary structure of the water absorbing material is a strip fiber, a reticular fiber or a cloth fiber with a plurality of holes, and the second capillary structure is a strip fiber.

In an embodiment of the present invention, the first capillary structure of the water absorbing material is laid on an outer surface of the cathode end. The cathode end further includes a current collector and a flow-field plate, and the first capillary structure of the water absorbing material is embedded between the current collector and the flow-field plate.

In an embodiment of the present invention, the cathode end further includes a current collector with a plurality of through holes, and the first capillary structure of the water absorbing material is laid on a surface of the current collector and at the edges of the through holes.

In an embodiment of the present invention, the cathode end further includes a flow-field plate with an air flow channel, and the first capillary structure of the water absorbing material is disposed on the inner side of the air flow channel.

In an embodiment of the present invention, the cathode end further includes a bipolar plate having an air flow channel on a surface thereof, and the air flow channel has a plurality of bends where the first capillary structure of the water absorbing material is disposed on.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The present invention will now be specified with reference to its preferred embodiments illustrated in the drawings, in which

FIG. 1 is a schematic view of a water flow system and a fuel supply system of a fuel cell according to the prior art;

FIG. 2 is a schematic view showing the basic structure of the cathode of the battery module of the fuel cell according to the prior art;

FIG. 3 is a schematic view of a water flow system and a fuel supply system of another fuel cell according to the prior art;

FIGS. 4A and 4B are the schematic views of two kinds of flow-field plates;

FIG. 5 is a schematic view showing an embodiment of a water flow system according to the present invention;

FIG. 6A to 6C are schematic views showing embodiments of three kinds of capillary structures according to the present invention;

FIG. 7 is a schematic view showing one embodiment of a fuel cell according to the present invention;

FIG. 8A is a schematic view showing another embodiment of the fuel cell according to the present invention;

FIG. 8B is a schematic view showing another embodiment of the fuel cell according to the present invention;

FIG. 9A is a schematic view showing a basic structure of a membrane electrode assembly according to one embodiment of the present invention;

FIG. 9B to 9C are schematic views showing a first capillary structure disposal according to one embodiment of the present invention;

FIG. 9D to 9E are schematic views showing another first capillary structure disposal according to one embodiment of the present invention;

FIG. 10A to 10B are schematic views showing the first capillary structure disposed on the membrane electrode assembly according to one embodiment of the present invention;

FIG. 11A to 11C are schematic views showing the first capillary structure disposed on a bipolar plate according to one embodiment of the present invention;

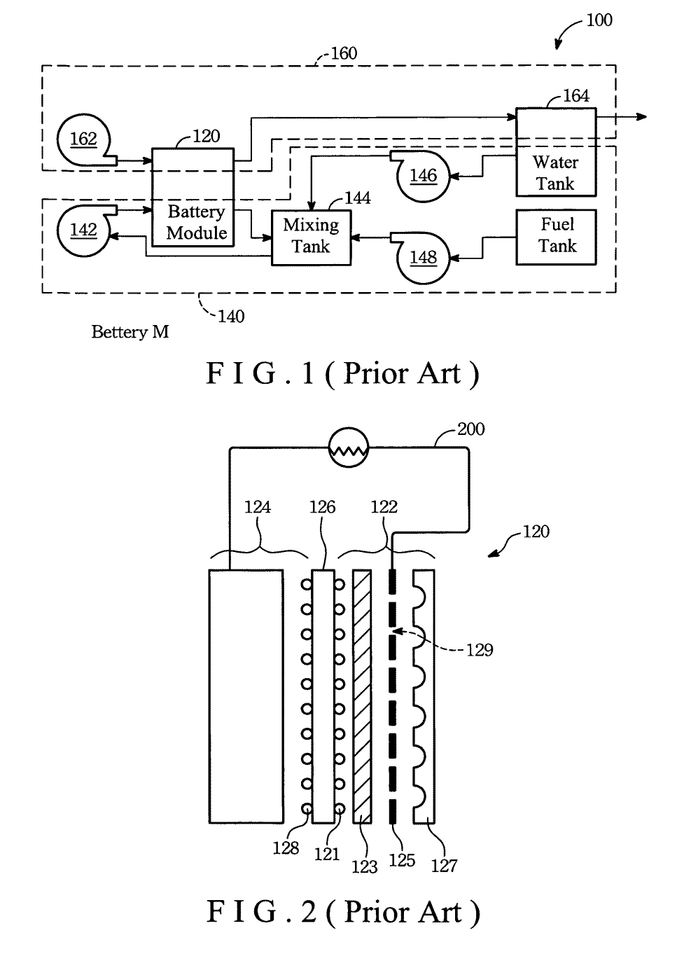

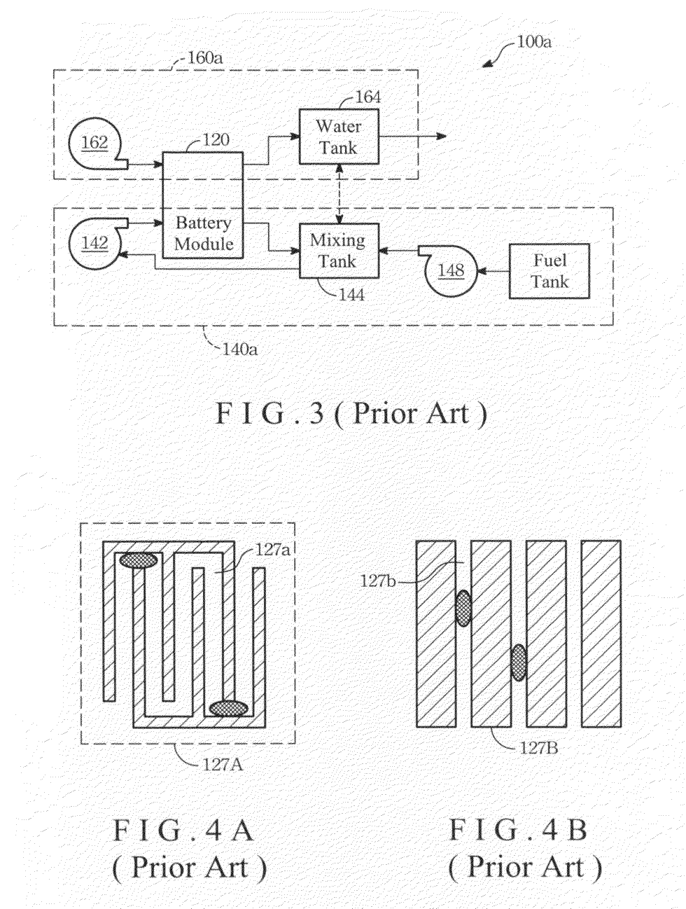

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

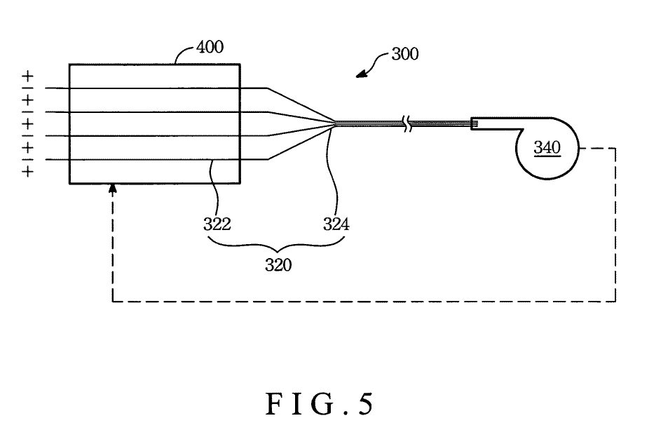

Referring to the FIG. 5, a water flow system 300 is laid in a fuel cell (no mark) and connected to a battery module 400 of the fuel cell. The battery module 400 has a cathode end (no mark) and an anode end (no mark). The water flow system includes a water absorbing material 320 and a pump 340. The water absorbing material 320 has a first capillary structure 322 and a second capillary structure 324. One end of the second capillary structure 324 is connected to the first capillary structure 322. The first capillary structure 322 contacts the cathode end of the battery module 400. The second capillary structure 324 is disposed at the outside of the battery module 400 and is separated from the cathode end. One end of the pump 340 is connected to the other end of the second capillary structure 324 of the water absorbing material 320 to pump the water in the second capillary structure 324. The pump 340 may pump the water from the first capillary structure 322 and the second capillary structure 324 continually or intermittently. In another embodiment, the other end of the pump 340 is connected to the anode end to pump the water in the second capillary structure 324 and sent it to the anode end of the battery module 400.

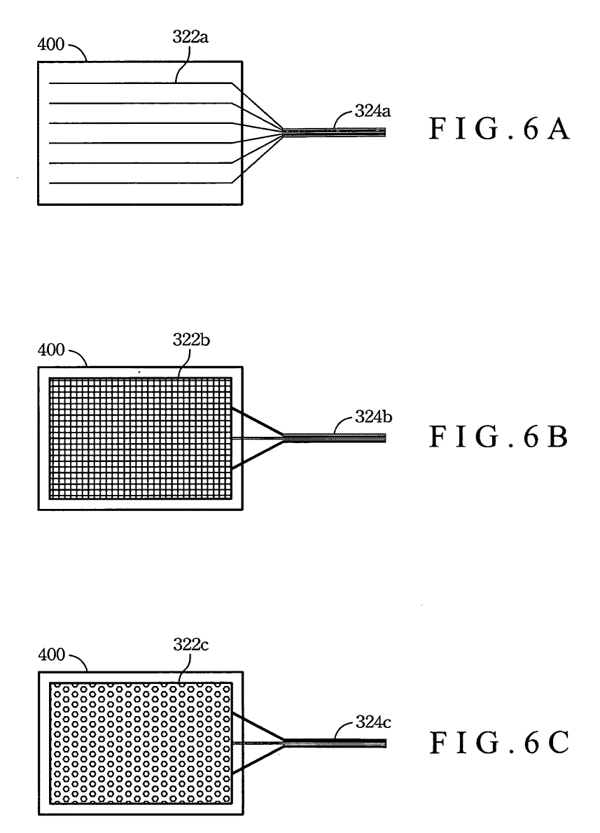

Referring to the FIGS. 6A-6C, a strip fiber 322a, a reticular fiber 322b and a cloth fiber 322c with a plurality of holes are respectively used as the first capillary structure 322 of the water absorbing material 320, a strip fiber 324a, 324b and 324c are respectively used as the second capillary structure 324. In another embodiment, the water absorbing material 320 includes a hydrophillic layer, such as titanium dioxide, to enhance the water absorbing ability. The water absorbing material 320 may be a cotton thread, a cotton cloth or a man-made fiber. In FIGS. 6A-6C, the first capillary structure 322 of the water absorbing material 320 is laid at outside surface of the cathode end of the battery module 400. In addition, the first capillary structure 322 may be disposed on a flow-field plate or a current collector, which are illustrated in details below.

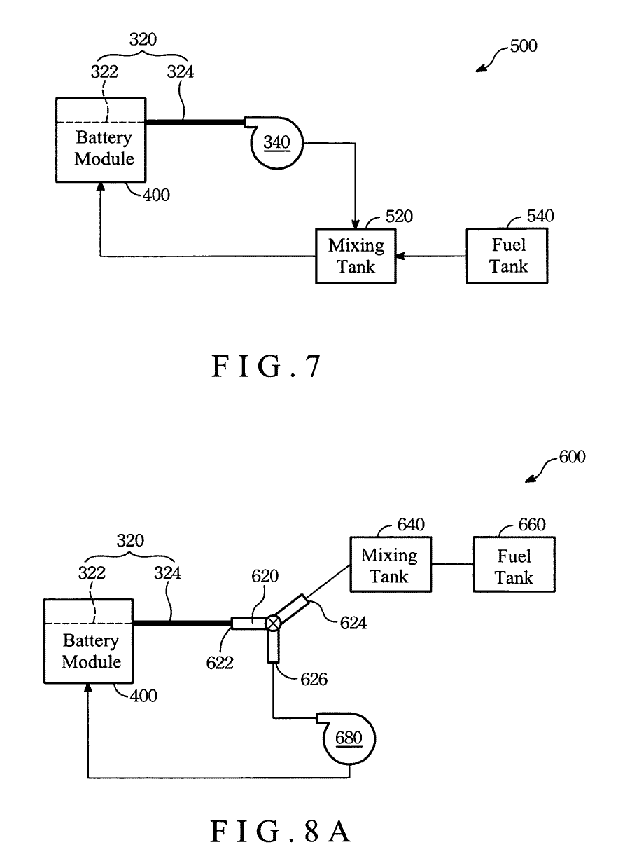

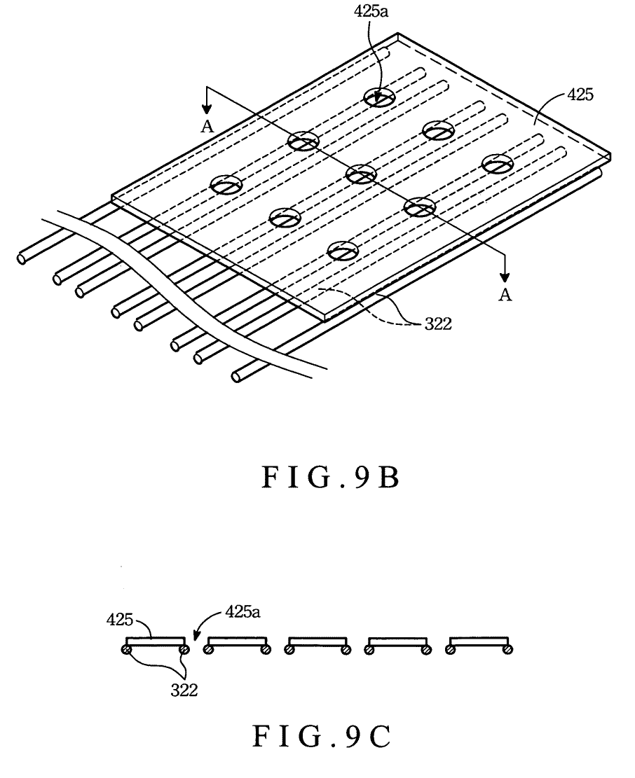

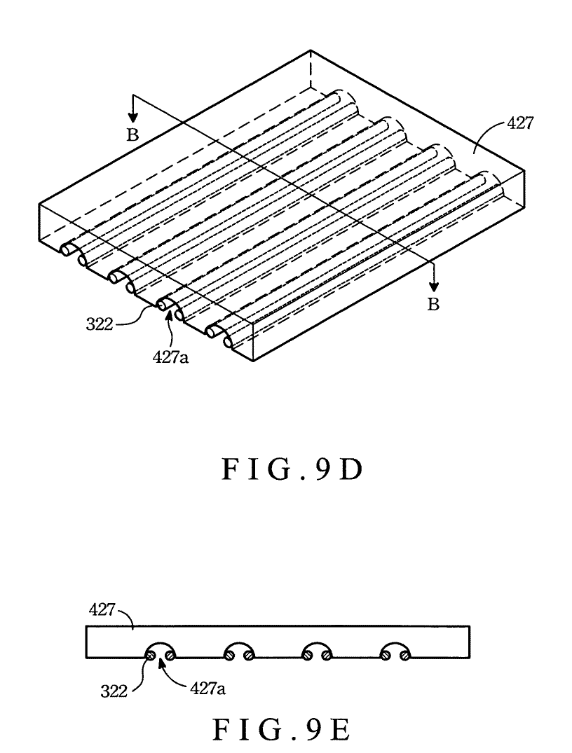

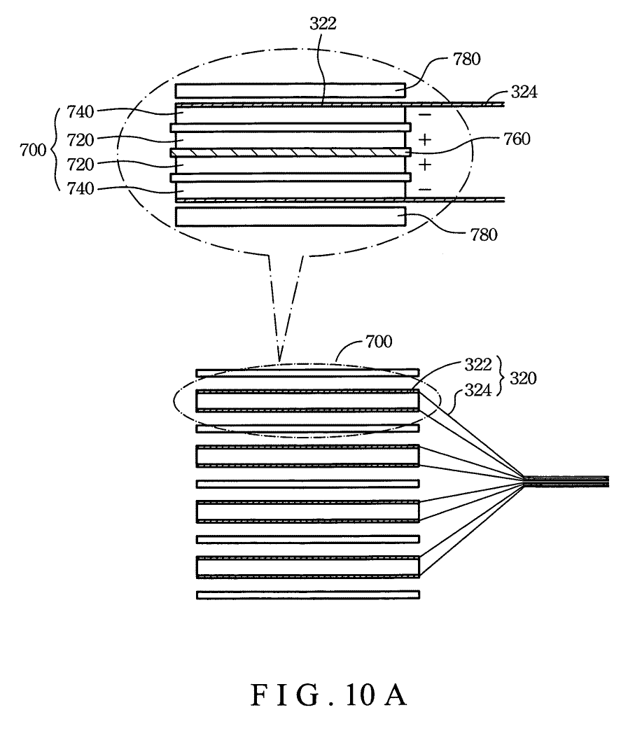

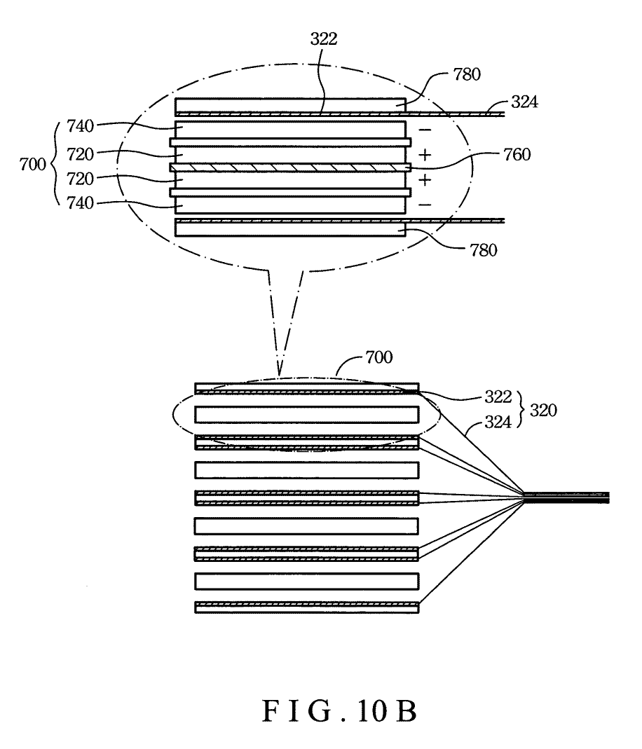

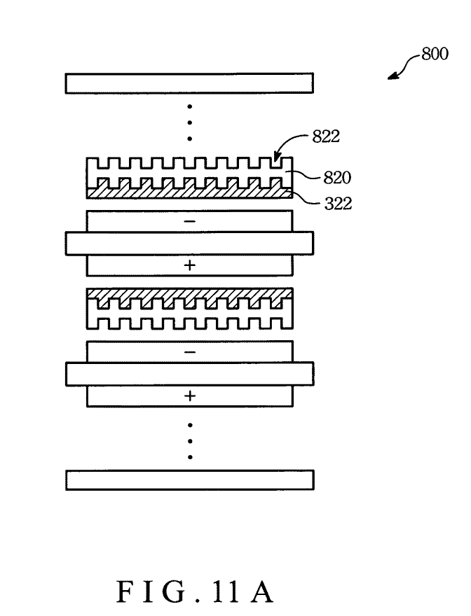

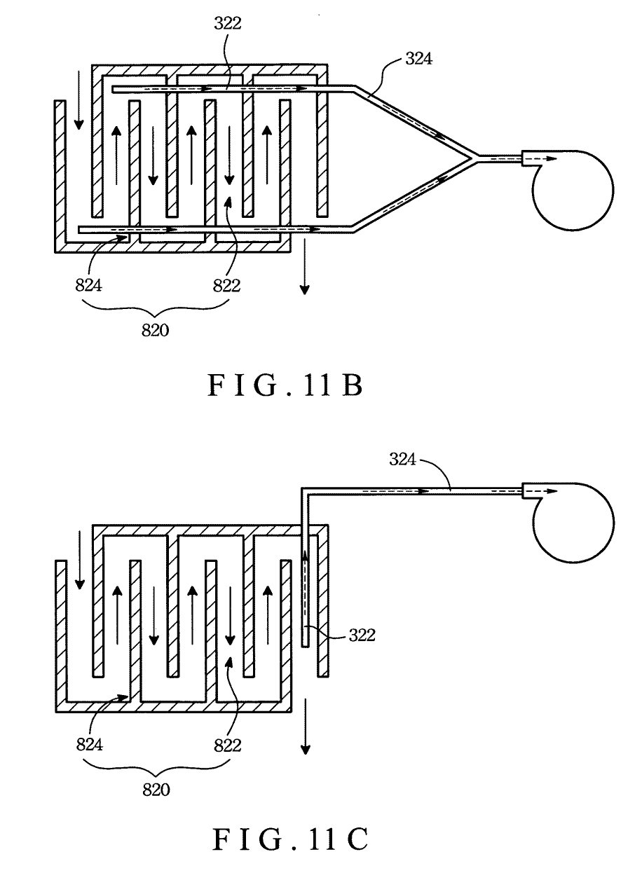

Referring to FIG. 7, according to the structure of above-mentioned water flow system 300, a fuel cell 500 includes the battery module 400, the water absorbing material 320, the pump 340, a mixing tank 520 and a fuel tank 540 in one embodiment. Refer to FIG. 2, FIG. 9A, FIGS. 10A-10B and FIG. 11A for the types of the battery module 400. The structure and the disposal of the water absorbing material 320 is the same as above-mentioned. The pump 340 is connected to the second capillary structure 324 of the water absorbing material 320. The fuel tank 540 supplies high concentration fuel. The mixing tank 520 mixes the water from the pump 340 and the fuel from the fuel tank 540 and then sends the mixture of the water and the fuel to the anode end (no mark) of the battery module 400. The connection between the mixing tank 520 and the battery module 400 or between the mixing tank 520 and the fuel tank 540 may use the pump to push the liquid in the pipe.

In FIG. 7, there is no valve between the pump 340 and the water absorbing material 320, which keeps it unobstructed. The pump 340 is turned on intermittently to ensure no water in the water absorbing material 320 so as to avoid leakage. In another embodiment, the pump 340 may be turned on continually to pump the water out of the cathode end quickly.

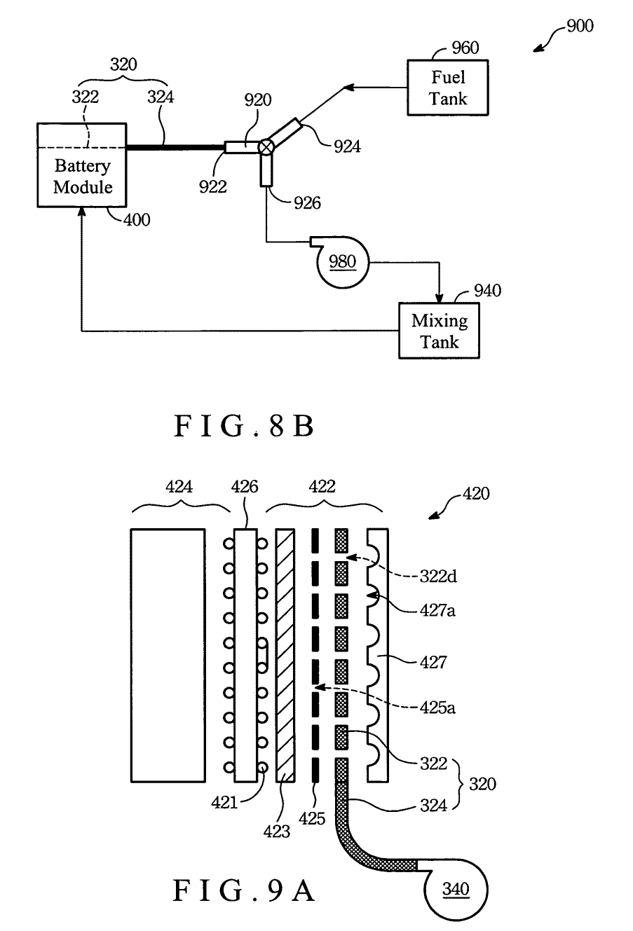

Referring to FIG. 8A, in another embodiment, a fuel cell 600 includes the battery module 400, the water absorbing material 320, a three-way valve 620, a mixing tank 640, a fuel tank 660 and a pump 680. The structures and the disposals of the battery module 400 and the water absorbing material 320 are the same as above-mentioned. The three-way valve 620 has a first connection 622, a second connection 624 and a third connection 626. The first connection 622 is connected to the second capillary structure 324 of the water absorbing material 320. The mixing tank 640 is connected to the second connection 624 of the three-way valve 620. The fuel tank 660 is connected to the mixing tank 640. The pump 680 is connected to the third connection 626 of the three-way valve 620 and the anode end (no mark) of the battery module 400. In this embodiment, after the first connection 622 of the three-way valve 620 is connected to the third connection 626, the pump 680 may pump the water from the water absorbing material 320 into the battery module 400; after the second connection 624 of the three-way valve 620 is connected to the third connection 626, the pump 680 may pump the fuel with a specific concentration from the mixing tank 640 into the battery module 400.

Referring to FIG. 8B, in another embodiment, a fuel cell 900 includes the battery module 400, the water absorbing material 320, a three-way valve 920, a mixing tank 940, a fuel tank 960 and a pump 980. The structures and the disposals of the battery module 400 and the water absorbing material 320 are the same as above-mentioned. The three-way valve 920 has a first connection 922, a second connection 924 and a third connection 926. The first connection 922 is connected to the second capillary structure 324 of the water absorbing material 320. The fuel tank 960 is connected to the second connection 922 of the three-way valve 920. The pump 980 is connected to the third connection 926 of the three-way valve 920 and the mixing tank 940. The mixing tank 940 is connected to the anode end (no mark) of the battery module 400.

In this embodiment, if the concentration of the fuel in the mixing tank 940 is lower than the minimum value of a predetermined concentration range, the pump 980 may send the fuel from the fuel tank 960 into the mixing tank 940 by connecting the second connection 924 to the third connection 926 of the three-way valve 920; if the concentration of the fuel in the mixing tank 940 is higher than the maximum value of the predetermined concentration range, the pump 980 may send the water from the water absorbing material 320 into the mixing tank 940 by connecting the first connection 922 to the third connection 926 of the three-way valve 920. Simultaneously, the second connection 924 of the three-way valve 920 is disconnected to the third connection 926 of that to keep the concentration of the fuel in the mixing tank 940 within the predetermined concentration range. According to this embodiment, the pump 980 may pump the water from the second capillary structure 324 or the fuel from the fuel tank 960 to the mixing tank 940 selectively.

According to the embodiments of the FIG. 8A and FIG. 8B, the pump 680 may be used between the water absorbing material 320 and the battery module 400, and between the mixing tank 640 and the battery module 400; the pump 980 may be used between the water absorbing material 320 and the battery module 400, and between the mixing tank 940 and the battery module 400. Thus the volume of the fuel cell is reduced and the using efficiency of the pumps 680 and 980 is increased.

The above-mentioned water flow system 300 may be applied in different kinds of fuel cells, such as PEMFC, DMFC or the fuel cell with bipolar plate, especially excellent in the portable fuel cell, as illustrated below.

Referring to FIG. 9A, the battery module 400 of the fuel cell includes at least a membrane electrode assembly 420 in no matter PEMFC or DMFC. The membrane electrode assembly 420 includes a polymer membrane 426, separating a cathode structure 422 from an anode structure 424. The polymer membrane 426 has the function of proton exchange. Accordingly, the cathode end (no mark) of the battery module 400 includes at least one cathode structure 422, while the anode end (no mark) of the battery module 400 includes at least one anode structure 424. The cathode structure 422 basically includes a catalyzer layer 421, a gas diffusion layer (GDL) 423, a current collector 425, the water absorbing material 320 and a flow-field plate 427.

The GDL 423 is usually a porous structure made of carbon cloth or carbon paper. Its water repellent material is usually fluoride-base materials such as PTFE (polytetrafluoroethylene), which may push water away from the surface of the catalyzer layer 421 to keep the catalyzer layer 421 dry. Material with carbon fiber is capable of transferring electrons, while the space between the carbon fiber has the water repellent function after applying PTFE treatment.

In the embodiment in FIG. 9A, the first capillary structure 322 of the water absorbing material 320 is embedded between the current collector 425 and the flow-field plate 427. In this embodiment, the first capillary structure 322 has a plurality of openings 322d corresponding to the through holes 425a in the current collector 425. Preferably, the first capillary structure 322 is attached to the current collector 425 and punched together with the current collector 425, thus the area covering the current collector 425 reaches largest size. The water absorbing material 320, such as foam, may help to remove the cathode water accumulated in the GDL 423 and also be connected to the pump 340 to remove the water absorbed by the water absorbing material 320.

In this embodiment, the removing path of the cathode water is as follows: first the cathode water enters the first capillary structure 322 via the catalyzer layer 421, the GDL 423 and goes through the through hole 425a of the current collector 425, then flows out of the membrane electrode assembly 420 by the second capillary structure 324, finally gets to the mixing tank or other water recovery equipment by the pump 340. In this way, the cathode water may flow to the anode end for reuse. The path for the air supplied to the catalyzer layer 421 is as follows: the air flows from an air flow channel 427a to the through hole 425a of the current collector 425, then flows to the surface of the catalyzer layer 421 via the GDL 423. Obviously, the water are gathered in the first capillary structure 322, while the air flows within the air flow channel 427a of the flow-field plate 427, the through hole 425a and the opening 322d, so that the air path and the water path are separated effectively without intervention.

Referring to FIG. 9B and FIG. 9C, the first capillary structure 322 is laid on the surface of the current collector 425 and at the edge of the through hole 425a. Its top view is shown in FIG. 9B and A-A sectional view shown in FIG. 9C.

Referring to FIG. 9D and FIG. 9E, the first capillary structure 322 is laid on the inner side of the air flow channel 427a. Its top view is shown in FIG. 9D and B-B sectional view shown in FIG. 9E.

Referring to the embodiment in FIG. 10A and FIG. 10B, the battery module includes a plurality of membrane electrode assemblies 700. The membrane electrode assembly 700 includes two anode structures 720 and two cathode structures 740. The two cathode structures 740 are exposed on two opposite outside surfaces of the membrane electrode assembly 700. The two anode structures 720 are disposed between inside surfaces of the two cathode structures 740. The two anode structures 720 are separated by a clapboard 760. FIG. 10A shows that the first capillary structure 322 of the water absorbing material 320 is laid on the outside surfaces of the two cathode structures 740. FIG. 10B shows that the first capillary structure 322 of the water absorbing material 320 is disposed on the flow-field plates 780 of the two cathode structures 740. The cathode structure of the conventional membrane electrode assembly is exposed outside, which is unable to pump the cathode water out from inside, however, the embodiments in FIGS. 10A, 10B and the above-mentioned structure may solve this problem.

Referring to FIG. 11A, it is the structure of a battery module 800 with a bipolar plate 820. The bipolar plate 820, such as the graphite plate, has one side at the cathode end and the other side at the anode end. There is an air flow channel 822 on the surface of the bipolar plate 820. The air flow channel 822 has a plurality of bends 824 shown as FIG. 11B and FIG. 11C. In FIG. 11B, the first capillary structure 322 of the water absorbing material 320 is disposed at the bends 824 of the air flow channel 822. In FIG. 11C, the first capillary structure 322 of the water absorbing material 320 is laid directly in the air flow channel 822 of the bipolar 820.

The test result of the embodiment according to the present invention is as follows: when there is no treatment on the cathode end, the cathode water may only vaporize naturally, 0.2 g per ten minutes. When the fan is used to blow air across the cathode end, more cathode water vaporizes, 0.4 g per ten minutes, better than no treatment. The water flow system in this embodiment may bring away 2.2 g water per ten minutes, very effective compared to the nature evaporation.

The embodiment according to the present invention uses capillary structure to collect the cathode water, extends the structure out of the battery module and sets it at the entrance of the pump to bring the water away. Compared with the conventional technology, the embodiment of the present invention collects liquid water into the water flow system without condensation, so there is no condenser and also the drainage is better, the water recovery rate is high. Moreover, the embodiment of the present invention does not need a lot of wind to vaporize the water, no extra fan needed, which may not only reduce electricity cost but also keep the high temperature of the fuel cell and increase its efficiency. The capillary structure may absorb the water, in case the water drops by gravity, which prevents the leakage. The embodiment according to the present invention uses the capillary to pull the cathode water from inside the battery module to the outside. The drainage is achieved by less energy so that the output power of the fuel cell is increased.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A water flow system for a fuel cell, the fuel cell having a battery module which has a cathode end and an anode end, and the water flow system comprising:
a water absorbing material, having a first capillary structure and a second capillary structure, one end of the second capillary structure connected to the first capillary structure, wherein the first capillary structure contacts the cathode end of the battery module and the second capillary structure is disposed outside the battery module and is separated from the cathode end;
a pump, having one end thereof is connected to the other end of the second capillary structure of the water absorbing material in order to pump the water in the second capillary structure.

2. The water flow system for the fuel cell of claim 1, wherein the first capillary structure of the water absorbing material is laid on an outer surface of the cathode end.

3. The water flow system for the fuel cell of claim 1, wherein the cathode end further comprises a current collector and a flow-field plate, and the first capillary structure of the water absorbing material is embedded between the current collector and the flow-field plate.

4. The water flow system for the fuel cell of claim 1, wherein the cathode end further comprises a current collector with a plurality of through holes, and the first capillary structure of the water absorbing material is laid on a surface of the current collector and at the edges of the through holes.

5. The water flow system for the fuel cell of claim 1, wherein the cathode end further comprises a flow-field plate with an air flow channel, and the first capillary structure of the water absorbing material is disposed on an inner side of the air flow channel.

6. The water flow system for the fuel cell of claim 1, wherein the cathode end further comprises a bipolar plate having an air flow channel on a surface thereof, and the air flow channel has a plurality of bends where the first capillary structure of the water absorbing material is disposed on.

7. The water flow system for the fuel cell of claim 1, wherein the water absorbing material is a cotton thread or a man-made fiber.

8. The water flow system for the fuel cell of claim 1, wherein the first capillary structure of the water absorbing material is a strip fiber, a reticular fiber or a cloth fiber with a plurality of holes, and the second capillary structure is a strip fiber.

9. A fuel cell, comprising:
a battery module, having a cathode end and an anode end;
a water absorbing material, having a first capillary structure and a second capillary structure, one end of the second capillary structure connected to the first capillary structure, wherein the first capillary structure contacts the cathode end of the battery module and the second capillary structure is disposed outside the battery module and is separated from the cathode end;
a three-way valve, having a first connection, a second connection, and a third connection, wherein the first connection is connected to the second capillary structure of the water absorbing material;
a mixing tank, connected with the second connection of the three-way valve;
a fuel tank, connected with the mixing tank; and
a pump, connected with the third connection of the three-way valve to pump the water from the second capillary structure, and also connected with the anode end of the battery module.

10. A fuel cell, comprising:
a battery module, having a cathode end and an anode end;
a water absorbing material, having a first capillary structure and a second capillary structure, one end of the second capillary structure connected to the first capillary structure, wherein the first capillary structure contacts the cathode end of the battery module and the second capillary structure is disposed outside the battery module and is separated from the cathode end; and
a pump, connected with the other end of the second capillary structure of the water absorbing material to pump the water from the second capillary structure.

11. The fuel cell of claim 10, further comprising:
a fuel tank, supplying fuel;
a mixing tank, accepting the water from the pump and the fuel from the fuel tank and mixing the water with the fuel, as well as sending the mixture of the water and the fuel to the anode end of the battery module.

12. The fuel cell of claim 11, further comprising:
a three-way valve, having a first connection, a second connection, and a third connection, wherein the first connection is connected to the other end of the second capillary structure, the second connection is connected to the fuel tank, and the third connection is connected to the pump so as to make the pump connected to the other end of the second capillary structure of the water absorbing material through the first connection and the third connection, wherein the pump selectively pumps the water from the second capillary structure or the fuel from the fuel tank to the mixing tank.

13. The fuel cell of claim 10, wherein the battery module comprises a plurality of membrane electrode assemblies, and the membrane electrode assembly comprises two anode structures and two cathode structures, the two cathode structures respectively disposed at two outside surfaces of the membrane electrode assembly, and the two anode structures disposed between inside surfaces of the two cathode structures.

14. The fuel cell of claim 10, wherein the first capillary structure of the water absorbing material is disposed on the outside surface of the cathode end.

15. The fuel cell of claim 10, wherein the cathode end further comprises an current collector and a flow-field plate, and the first capillary structure of the water absorbing material is embedded between the current collector and the flow-field plate.

16. The fuel cell of claim 10, wherein the cathode end further comprises an current collector with a plurality of through holes, and the first capillary structure of the water absorbing material is disposed on a surface of the current collector and at the edges of the through holes.

17. The fuel cell of claim 10, wherein the cathode end further comprises a flow-field plate with an air flow channel, and the first capillary structure of the water absorbing material is disposed on the inner side of the air flow channel.

18. The fuel cell of claim 10, wherein the cathode end further comprises a bipolar plate having an air flow channel on a surface thereof, and the air flow channel has a plurality of the bends where the first capillary structure of the water absorbing material is disposed on.

19. The fuel cell of claim 10, wherein the water absorbing material is a cotton thread or a man-made fiber.

20. The fuel cell of claim 10, wherein the first capillary structure of the water absorbing material is a strip fiber, a reticular fiber or a cloth fiber with a plurality of holes and the second capillary structure is a strip fiber.
